(19) United States
(12) Patent Application Publication
(10) Pub. No.: US 2008/0217388 A1
(43) Pub. Date: Sep. 11, 2008

(54) BOTTLE DECORATION AND/OR LABELLING DEVICE

(76) Inventor: Susan Margaret Brayshaw, Leeds (GB)

Correspondence Address: Dickinson Wright PLLC, Ste. 2000, 38525 Woodward Avenue, Bloomfield Hills, MI, 48304-2970, US

(21) Appl. No.: 12/044,538

(22) Filed: Mar. 7, 2008

Related U.S. Application Data
(60) Provisional application No. 60/893,945, filed on Mar. 9, 2007.

(51) Int. Cl. B65D 23/08; B65D 65/04; G09F 1/08

(52) U.S. Cl. 229/89; 215/386; 40/310

(57) ABSTRACT

A blank for adorning a receptacle, typically a bottle. The blank has a body portion defined between a pair of side edges which can be wrapped around a body portion of the receptacle with the pair of side edges brought together in overlapping manner behind the bottle body portion and which can be fixedly connected together. The blank is further provided with a pair of limb portions having interlocking slits, provided proximate their tips, which extend upwardly of from the upper edge of the blank and at a generally acute angle thereto so as to be capable of being curved around the neck of the bottle and connected to one another to prevent the blank from sliding downwardly off of the bottle. One surface of the blank may be printed with the design of a garment such that the blank and the receptacle work symbiotically to give the impression that the bottle is of human form dressed in the garment. Additionally, portions of the blank may be designated as areas on which a written message can be inscribed.

This application claims priority to U.S. Provisional Application Ser. No. 60/893,945, filed Mar. 9, 2007, and is incorporated herein by reference.

### 1. TECHNICAL FIELD

This invention relates to a bottle decoration and optionally labelling device, and more specifically to a blank capable of being pre-printed and mass produced, and which in use is adapted to be conformed around a bottle to provide a novel decoration and/or labelling means therefore.

### 2. RELATED ART

It will be readily apparent to any reader hereof that the majority of the bottles used to contain wine, spirits and Champagne are of the same general shape and furthermore, the same general dimensions. Although this specification refers to drinks bottles specifically, it will be immediately understood by the skilled reader that the invention is not limited in its application to bottles containing a particular drink. Furthermore, it is also to be understood that this invention may have application to any type of receptacle being having at least a base from which a lower, body portion of the receptacle extends upwardly into an upper neck portion of generally lesser diameter than said body portion, said neck portion ultimately terminating in a mouth through which, in conventional usage, the contents of the receptacle may be evacuated. Excepting bottles, vases and the like are to be considered within this definition. In the context of this invention, the particular cross-sectional shape of the bottle is not particularly important, but as the majority of bottles are of generally circular cross sectional shape, the description of the invention will be directed to such.

### SUMMARY OF THE INVENTION

Indeed, it is within the contemplation of the inventor that the invention hereinafter described may be easily and simply adapted or modified for application to any type of receptacle in which a drink or other substance is usually contained and which is occasionally offered to another individual as a gift. Obviously, bottles of wine and Champagne are often given as gifts, but other examples may include perfume bottles, condiments, preserved antipasto, pasta and the like. Notwithstanding the above, this specification refers predominantly to the labelling and decoration of wine and champagne bottles for brevity.

As the majority of wine and Champagne bottles are of glass, labelling of such has traditionally been accomplished by using adhesive labels applied mechanically or by hand around the outer cylindrical surfaces of the body portion of the bottle, and often around the neck portion. Of course, the mouth of the bottle is traditionally sealed with a cork or the like, and a metal foil or thin plastics material covering is applied over the mouth and the upper reaches of the neck portion to further enhance the appearance and identity of the bottle. Of course there are various other means for adorning bottles, including shrinking plastics film material sleeves around the bottle to provide the bottle with both printed informational material and additionally an improved structural rigidity on account of the compression of the bottle achieved by the film shrinking process. Further alternatives include direct printing onto the surface of a bottle, although this is not a simple process on account of the curvature of the outer surfaces of bottles in general.

As will be appreciated by the reader, the fact that the bottling industry is very well established has resulted in the labelling and decoration of such bottles being an equally well developed industry, and one with which the invention herein described is not primarily concerned. Moreover, the invention described herein is concerned with the further decoration and adornment of pre-labelled bottles and receptacles.

Traditionally, the labelling and decoration of drinks bottles is currently effected exclusively by the producers, manufacturers or occasionally the distributors of the beverage in question on account of the fact that they are typically supplying many thousands, hundreds of thousands or even millions of bottles of their products. From the point of view of the consumer, there is not currently available any conveniently applicable means for further decorating, adorning or customising the appearance of a simple, pre-labelled bottle of wine or champagne. Of course, there are a wide variety of pre-printed and blank self-adhesive labels which may be applied to a bottle prior to its being given as a gift and on which some message to the recipient of the gift may be inscribed, but this is a fairly rudimentary and crude form of personalising a bottle of wine or other beverage.

Traditional wrapping techniques may also be employed, with the possible addition of personalised gift tags having suitable messages written thereon being taped or possibly looped around the neck of the bottle after wrapping, but again such measures may be considered basic, lacking imagination, and furthermore failing to provide any clearly identifiable decoration of the bottle itself. Indeed merely wrapping a bottle not only makes it immediately evident to the recipient that the gift is a bottle of some description, but also merely conceals the particular brand of the bottle being given.

The inventor herefor has realised that in the vast majority of circumstances where a bottled beverage is being offered as a gift, it may be that the bottle would be far better received if it could be provided with a decorative novelty aspect.

According to the present invention there is provided a blank for adorning a receptacle having a base from which a lower body portion of the receptacle upwardly extends, said lower body portion further extending into an upper neck portion of reduced cross-sectional dimension as compared to the cross-sectional dimensions of the lower body portion of said receptacle, said blank having a body portion defined between a pair of side edges proximate which are provided fixing means enabling the body portion of said blank to be wrapped around the body portion of the receptacle and the pair of edges fixedly connected, said blank body portion being further defined by a lower edge which in use is proximate the base of the receptacle and an upper edge, and wherein the blank is further provided with a pair of limb portions having fixing means provided proximate their tips, said limb portions extending upwardly from the upper edge and at a generally acute angle thereto so as to be capable of being curved around the neck portion of the receptacle and fixedly secured to one another to prevent the blank from sliding downwardly off of said receptacle.

Preferably, the fixing means provided proximate the side edges of the base portion and proximate the tips of the limb portions of the blank are in the form of either adhesive tabs which may be provided on one or both of the side edges of the blank base portion, or on one or both of the tips of the limb portions.

Alternatively, the side edges and the tips of the limbs may be provided with cooperating tab and slit arrangements which interlock to achieve the connection of the side edges to one another, or of the limbs to one another.

It is to be understood from the above that any combination of fixing means may be employed to the side edges and the limb tip as desired as long as these can be secured to one another in accordance with the invention.

In the case of the limbs, a pair of slits may be provided proximate their tips, transverse to the longitudinal axis of said slits, one slit being provided in the upper edge proximate the tip of one of the limbs, the other slit being provided in the lower edge proximate the tip of the other limb so that connection thereof may be achieved by sliding the part of the limb portion beneath or above the slit in one limb portion into the slit provided in the alternate limb portion in interlocking fashion.

It is yet further preferable that the fixing means provided on both the limb tips and the side edges of the blank are adjustable to allow for receptacle of different sizes. For example, there may be a plurality of slits provided at different distances along the limb tips to allow for different receptacle neck sizes, and in the case of the side edges, the adhesive tabs may be overlapped and adhered together so that they may be overlapped to a greater or lesser degree depending on the receptacle body portion cross-sectional dimensions.

Preferably the depth of said base portion and the length of said limb portions are chosen such that the body portion of the bottle is substantially concealed by the blank when in place, and the limb portions are curved around the neck portion of the bottle and fixedly connected substantially above the join between the side edges of the blank body portion.

Most preferably, one surface of the blank is printed with the design of a garment traditionally including some form of attachment around the neck of a wearer such that in use, the blank and the receptacle work symbiotically to give the impression that the bottle is of human form dressed in the garment. Example of designs include aprons, pinafores, waistcoats, gowns, basques, and the like.

Further preferably, the blank is cut from 300 g/m² card stock or similar, and may optionally be embossed, provided with foil trimmings, varnished, lacquered or otherwise further decorated so as to increase the aesthetic appeal of the article. Of course any combination of these techniques may be employed.

Yet further preferably the blank is provided with a label area which may be disposed between the upper edge of the blank body portion one of the limbs, said label portion having at least one free edge so that in use, said free edge is not constrained to follow the curvature of the remainder of the body portion of the blank or the limb portions and thus protrudes outwardly of the general cylindrical shape of the blank in position.

This renders said label portion instantly recognisable as such which further promotes the usefulness of the device as a whole, because not only is the overall aesthetic appearance of the receptacle improved, but there is no requirement for attachment of a separate label.

### THE DRAWINGS

A specific embodiment of the invention will now be described by way of example with reference to the accompanying drawings wherein:

FIG. 1 shows a plan view of a pre-printed blank according to the invention, and

FIG. 2 shows a schematic perspective view of the blank of FIG. 1 conformed around a bottle in accordance with the proposed use of the blank.

### DETAILED DESCRIPTION

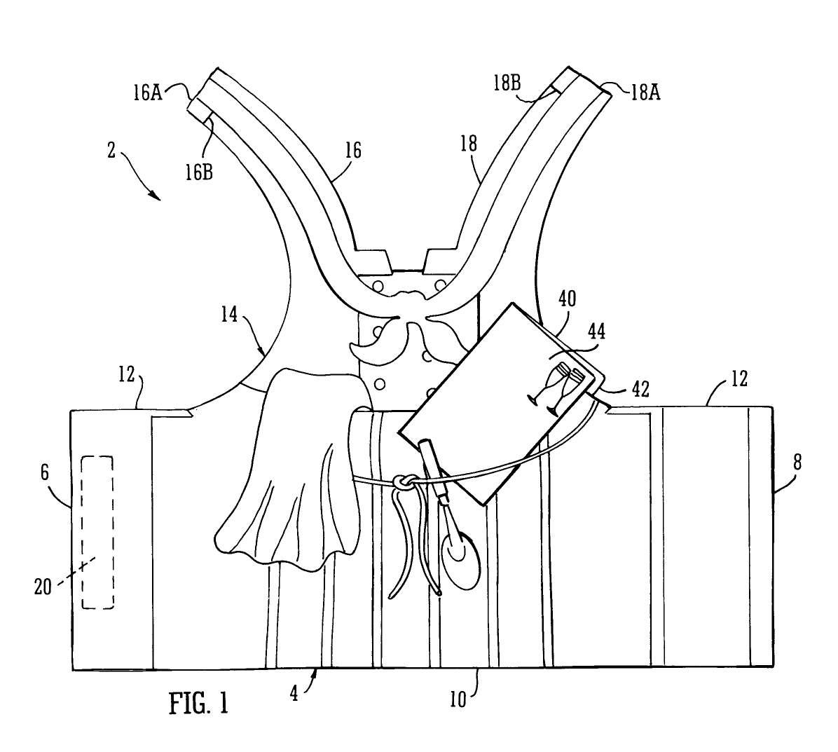

Referring firstly to FIG. 1, those is indicated generally at 2 a blank having a body portion 4 defined between a pair of side edges 6, 8, a lower edge 10, and an upper edge 12 from which upwardly extends a secondary portion indicated generally at 14 and which consists essentially of a pair of limbs 16, 18 having longitudinal axis (not shown) which notionally intersects with the upper edge 12 making an acute angle therewith. As can be seen from FIG. 1, the limbs 16, 18 diverge from one another as they extend upwardly and away from the upper edge 12 in accordance with the invention. In this Figure, secondary portion 14 joins the limbs 16, 18 to the body portion 4 of a blank 2, and this is to be considered a preferred feature in cases where the blank 2 is to be printed in the form of a chef's apron as generally depicted in FIG. 1. Additionally, said secondary portion 14 may be a useful element of the blank 2 in that it ensures that the limbs 16, 18 extend a sufficient distance from the upper edge 12 to ensure that on the one hand they can be wrapped around the neck of a wine bottle or other receptacle such that their tips 16a, 18a can be secured to one another as hereinafter described.

To achieve the connection of the tips of the limbs 16a, 18a to one another, in this specific embodiment at least, the limbs 16, 18 are provided with oppositely orientated slits 16b, 18b in the lower and upper edges respectively of said limb such that when the limb tips are wrapped around the neck of a bottle or receptacle, the slits 16b, 18b can be slid over one another thus causing the limb tips 16a, 18a to be co-operatingly secured to one another. Of course, alternate fixing means may be employed, such as adhesive tabs, pads, or by the provision of suitable tab and slot formations proximate the limb tips 16a, 18a as is well know in the art for interlocking opposing portions of a blank together.

In order that the side edges 6, 8 of the body portion 4 of the blank may be secured to one another as the blank 2 is wrapped around a bottle or receptacle, in this embodiment an adhesive pad 20 is provided on the underside of the blank 2, the side being shown in FIG. 1 being the outwardly facing or upper surface of the blank 2. Again, alternate fixing means may be provided proximate the edges 6, 8, such as the previously mentioned tab and slot formations.

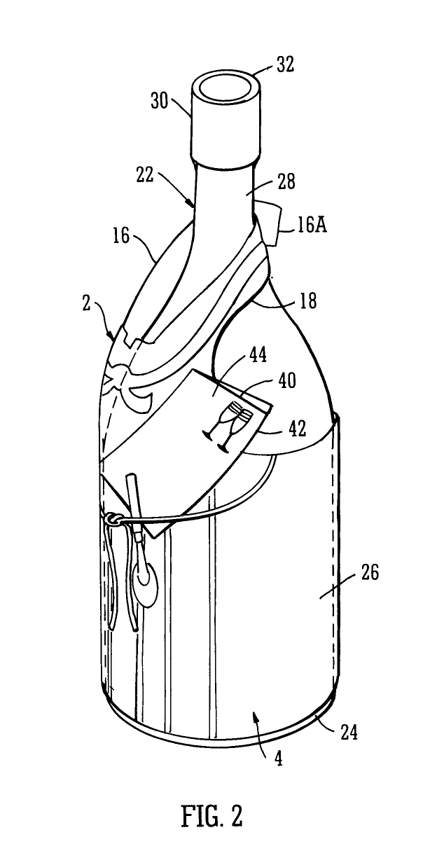

Referring now to FIG. 2, in which the blank 2 is shown wrapped around a bottle indicated generally by reference numeral 22 and secured thereto in a manner hereinafter described.

Although the following description provides exclusive reference to a bottle 22, it will be instantly appreciated by those skilled in the art that a wide variety of receptacles may be used, and which generally comprise a base 24 from which upwardly extends a body portion 26, said body portion then further upwardly extending into a reduced diameter neck portion 28, which in FIG. 2 is shown covered by a traditional wine bottle foil or plastics material cap 30 which conceals a bottle mouth 32 at which the neck portion 28 terminates, said mouth 32 being traditionally stoppered by a cork (not shown).

In use, the blank 2 is wrapped around the bottle 2 by firstly conforming the blank body portion 4 around the bottle body portion 26 and joining the surfaces of said blank body portion 4 to one another in the region of the blank side edges 6, 8 by means of the adhesive tab 20 (which in a production version may be covered with a release paper) or by other suitable connection means not shown or described but contemplated within the scope of this invention.

Once this has been achieved, it is a simple matter then of similarly conforming the limbs 16, 18 around the neck portion 28 of the bottle and interlockingly connecting said limbs in the region of their tips 16a, 18a by sliding the slots 16b, 18b over one another as previously described.

It is important to mention that without the limbs 16, 18 and their interlocking connection in the neck region 28 of the bottle 22, the device described herein would constitute no more than a simple sleeve which would be prone to sliding over and off the bottle 22, either upwardly thereof over the neck 28 of the bottle 22, or downwardly off the base 24. Accordingly, it is the provision of the limbs 16, 18 and their interlocking connection proximate their tips 16a, 18a which prevents this from occurring, and simultaneously, depending on the decorative printed design applied to the outer surface blank 4, provides a novel aesthetic appeal for the bottle as can be seen in FIG. 2. For instance, the bottle in FIG. 2 is essentially dressed in a chef's apron and with a little imagination, can take on the appearance of a chef.

A further feature of the blank 4 is the provision of protruding edges 40, 42 as shown in FIG. 1 which partially define a label area 44 of the blank. In its flat, unused condition, the label area 44, and in particular the region of the label area 44 proximate said edges 40, 42 lies in the same plane as the remainder of the blank 2. However as can be seen in FIG. 2, conforming the body portion 4 of the blank 2 around the outer surfaces of the bottle body portion 26, together with the inherent stiffness or rigidity of the card stock from which the blank 2 is produced, causes the upper region of the label area 44 proximate the protruding edges 40, 42 to resist the tendency to become curved with the remainder of the blank body portion 4 with the result that said region of said label area 44 proximate said edges 40, 42 and in particular the corner defined by edges 40, 42 stands proud of the outermost surface of the blank body portion 4 when viewed from above and thus is easily and instantly identifiable as a label area of the blank, despite forming an integral part of the blank 2.

1. A blank for adorning a receptacle having a base from which a lower body portion of the receptacle upwardly extends, said lower body portion further extending into an upper neck portion of reduced cross-sectional dimension as compared to the cross-sectional dimensions of the lower body portion of said receptacle, said blank having a body portion defined between a pair of side edges proximate which are provided fixing means enabling the body portion of said blank to be wrapped around the body portion of the receptacle and the pair of side edges thereof to be fixedly connected, said blank body portion being further defined by a lower edge which in use is proximate the base of the receptacle and an upper edge, and wherein the blank is further provided with a pair of limb portions having fixing means provided proximate their tips, said limb portions extending upwardly from the upper edge and at a generally acute angle thereto so as to be capable of being curved around the neck portion of the receptacle and fixedly secured to one another to prevent the blank from sliding downwardly off of said receptacle.

2. A blank according to claim 1 wherein the fixing means provided proximate the side edges of the base portion and proximate the tips of the limb portions of the blank are selected from the group of
a. adhesive tabs, or
b. cooperating tab and slit arrangements which interlock
c. interlocking slit arrangements
which may be provided on one or both of the side edges of the blank base portion, and/or on one or both of the tips of the limb portions.

3. A blank according to claim 2 wherein the same type of fixing means is provided on the side edges of the base portion and proximate the tips of the limb portions

4. A blank according to claim 1 wherein a pair of slits is provided proximate the tips of the limb portions, transverse to the longitudinal axis of said slits, one slit being provided in the upper edge proximate the tip of one of the limbs, the other slit being provided in the lower edge proximate the tip of the other limb so that connection thereof may be achieved by sliding the part of the limb portion beneath or above the slit in one limb portion into the slit provided in the alternate limb portion in interlocking fashion.

5. A blank according to claim 2 wherein the fixing means provided on both the limb tips and the side edges of the blank are adjustable to allow for receptacle of different sizes.

6. A blank according to claim 5 wherein there are a plurality of slits provided at different distances along the limb tips to allow the limbs to be connected to one another around receptacles having neck portions of differing sizes.

7. A blank according to claim 5 wherein adhesive tabs may be overlapped and adhered together in such a manner that they may be overlapped to a greater or lesser degree depending on the receptacle body portion cross-sectional dimensions.

8. A blank according to claim 1 characterised in that the depth of said base portion and the length of said limb portions are chosen such that the body portion of the bottle is substantially concealed by the blank when in place, and the limb portions are curved around the neck portion of the bottle and fixedly connected substantially above the join between the side edges of the blank body portion.

9. A blank according to claim 1 wherein one surface of the blank is printed with the design of a garment traditionally including some form of attachment around the neck of a wearer such that in use, the blank and the receptacle work symbiotically to give the impression that the bottle is of human form dressed in the garment.

10. A blank according claim 1 wherein the blank is cut from 300 g/m² card stock.

11. A blank according to claim 1 wherein the blank is decorated using one or more of the following techniques:
a. embossing
b. foil trimming
c. varnishing,
d. lacquering.

12. A blank according claim 1 wherein said blank is provided with a label area which is disposed between the upper edge of the blank body portion one of the limbs, said label portion having at least one free edge so that in use, said free edge is not constrained to follow the curvature of the remainder of the body portion of the blank or the limb portions and thus protrudes outwardly of the general cylindrical shape of the blank in position.
